(19) United States
(12) Patent Application Publication
(10) Pub. No.: US 2022/0320607 A1
(43) Pub. Date: Oct. 6, 2022

(54) Charging and reconditioning an electrochemical cell

(71) Applicant: Orca Sciences, LLC, Kirkland, WA (US)

(72) Inventors: Ian Salmon McKay, Seattle, WA (US); Lowell Lincoln Wood, JR., Bellevue, WA (US)

(21) Appl. No.: 17/707,252

(22) Filed: Mar. 29, 2022

Related U.S. Application Data
(60) Provisional application No. 63/168,249, filed on Mar. 30, 2021.

(51) Int. Cl. H01M 10/44

(52) U.S. Cl. CPC H01M 10/44; H01M 4/134

(57) ABSTRACT

Method and devices for charging and reconditioning an electrochemical cell by applying one of a current and a voltage for achieving a galvanic phase and an electrolytic phase in alternating periods.

### CROSS-REFERENCE TO RELATED APPLICATIONS

This application claims the benefit of and priority to U.S. Provisional Patent Application No. 63/168,249, filed Mar. 30, 2021, the entire disclosure of which is hereby incorporated by reference as if set forth in its entirety herein.

### TECHNICAL FIELD

The present application relates generally to a method of charging an electrochemical cell and, more particularly to a method of charging and reconditioning an electrochemical cell for inhibiting growth of dendrites.

### BACKGROUND

Generally, when electrochemical batteries are charged at steady rates, undesirable changes often take place at the negative electrode that may damage the battery. Such changes include the growth of dendrites from metal electrodes, sintering and migration of materials in porous electrodes, and cracking in intercalation materials.

Specifically, when the batteries are charged at constant current, a steady-state concentration profile emerges in the vicinity of the electrodes as the electroactive species is consumed at the electrodes and replenished by diffusion or electromigration or both from the bulk electrolyte. Since the electrochemical reaction rate at the electrodes is proportional to the concentration of the electroactive species, portions of the electrodes that are nearer to the bulk electrolyte experience higher reaction rates. For deposition reactions, this dynamic may lead to positive feedback—any small promontory on the electrode is exposed to a slightly higher concentration of the species to be plated, which results in a slightly higher promontory, then a slightly higher concentration, etc. For diffusion limited electroplating (the usual case for high-rate charging) the positive feedback follows a roughly linear reaction rate dependence. For inter-electrode spacing L and dendrite height δ, the reaction rate at x=L is˜Diffusivity×Bulk Concentration/L. The reaction rate at x=1−δ is˜Diffusivity×Bulk Concentration/(L−δ).

In the case of metal deposition on solid electrodes, the positive feedback may lead to the rapid growth of metal dendrites which may span the inter-electrode space, creating short-circuits and destroying the cells. In the case of porous electrodes, the consequence is similar, and in sintered structures this may lead to necking and the migration of active material towards the outer layers of the electrode, which may cut off a portion of the electrode from the electrolyte and cause capacity fade. Furthermore, in the case of intercalation electrodes, the nonuniform concentration profile contributes to overloading of the outer part of the electrode, and underloading of the inner part, which leads to high strain conditions and capacity loss as parts of the electrode fracture and lose electrical connection to the external circuit.

One known solutions for the problem of metal dendrites is electrodeposition. For example, pulsed (most often unipolar square wave) techniques are recognized as effective methods for achieving more uniform electrodeposits, especially for deposition on nonplanar surfaces. By allowing the concentration of the deposited species to equilibrate in the vicinity of the electrode between pulses, such techniques enable more equal plating rates than are possible in the DC regime. Since the unipolar DC pulse strategy relies on electrolyte equilibration, it can partially stop dendrite formation, however, the unipolar DC pulses fail to remove dendrites.

Therefore, there is a need for a method for charging and reconditioning an electrochemical cell to overcome these disadvantages.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

According to one aspect, embodiments relate to a method for one or more of charging and reconditioning an electrochemical cell for inhibiting growth of dendrites, wherein the method includes applying one of a current and a voltage for achieving a galvanic phase and an electrolytic phase in alternating periods.

In some embodiments the magnitude of the current applied during the galvanic phase is less than the magnitude of the current applied in the electrolytic phase.

In some embodiments a magnitude of a maximum value of the current applied in the galvanic phase is greater than a magnitude of a maximum value of the current applied in the electrolytic phase.

In some embodiments the electrolytic phase and the galvanic phase switch with a frequency between 0.5 and 4 times of Sand's time for a negative electrode.

In some embodiments a magnitude and a duration of the applied current in the electrolytic phase is characterized to limit a reaction rate at the negative electrode by electrolyte conduction, and a magnitude and a duration of the applied current in the galvanic phase is characterized to limit a reaction rate at the negative electrode by reaction activation energy.

In some embodiments time-varying or steady-state conditions are applied at the negative electrode, wherein the conditions comprise one more variables including temperature, strain state, strain direction, and pressure.

In some embodiments the method includes periodic voltage excursions for removing adventitious contaminant layers formed during an operation of the electrochemical cell.

In some embodiments the method includes applying a voltage waveform to the electrochemical cell driving a multi-step reaction, wherein the voltage waveform is calibrated to stabilize different transition states along a reaction path.

In some embodiments periodic voltage excursions into gas-generating regimes are used for sterilizing incipient biofilm layers of the metal electrode cells. In some embodiments the gas-generating regimes comprise hydrogen and chlorine evolution regimes.

In some embodiments the method includes integrating microelectronic buck converters into the electrochemical cell, wherein the electrochemical cell is a battery with one form factor out of A, AA, and AAA form factors.

In some embodiments the method includes applying a time-varying charging waveform to an electrode-electrolyte interface of the electrochemical cell under an applied mechanical stress, wherein the applied stress is orthogonal to the electrode-electrolyte interface. In some embodiments, the applied stress is achieved by applying compressive forces to the metal electrode cells. In some embodiments, the stress is applied periodically by applying a compressive stress to the negative electrode during a charging pulse and removing the compressive stress during a stripping or relaxed phase. In some embodiments the stress is applied by mounting the negative electrode onto a piezoelectric substrate. In some embodiments the stress is applied by clamping the metal electrode cells in a mechanical actuator.

In some embodiments the electrochemical cell comprises one or more electrodes made of zinc, lithium, and iron.

In yet another aspect, embodiments relate to a device for charging and reconditioning an electrochemical cell, the device including a circuit for measures a current-voltage relationship of the electrochemical cell at one or more frequencies to generate impedance spectra, a circuit for computing the optimal duty cycle and a bipolar magnitude for a charging waveform using the impedance spectra, and a circuit for applying one of a current and a voltage for achieving a galvanic phase and an electrolytic phase in alternating periods using the charging waveform.

In some embodiments the impedance spectra is generated periodically throughout the charging process and the charging waveform is changed during the charging process based on the periodic generation of the impedance spectra.

In some embodiments the device includes a circuit for converting a DC galvanic charging current into an alternating electrolytic and galvanic charging current that is partially or wholly contained within the housing of the electrochemical cell.

In some embodiments the circuit for applying one of a current and a voltage for achieving a galvanic phase and an electrolytic phase in alternating periods is partially or wholly contained within the housing of the electrochemical cell.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 is a graph illustrating a model of growth on a single thin dendrite in a periodic array; and

FIG. 2 is graph illustrating an effect of an electrochemical fire polishing in shrinking a dendrite.

Persons skilled in the art to which this disclosure belongs will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those of ordinary skill in the art having the benefit of the description herein.

### DETAILED DESCRIPTION

For the purpose of promoting an understanding of the principles of the disclosure, reference will now be made to the embodiment(s) illustrated in the figures and specific language will be used to describe them. It will nevertheless be understood that no limitation of the scope of the disclosure is thereby intended. Such alterations and further modifications to the disclosure, and such further applications of the principles of the disclosure as described herein being contemplated as would normally occur to one skilled in the art to which the disclosure relates are deemed to be a part of this disclosure.

It will also be understood by those skilled in the art that the foregoing general description and the following detailed description are exemplary and explanatory of the disclosure and are not intended to be restrictive thereof.

The terms “comprises,” “comprising,” or any other variations thereof, are intended to cover a non-exclusive inclusion, such that a process or method that comprises a list of steps does not include only those steps but may include other steps not expressly listed or inherent to such a process or a method. Similarly, one or more devices or sub-systems or elements or structures or components preceded by “comprises . . . a” does not, without more constraints, preclude the existence of other devices, other sub-systems, other elements, other structures, other components, additional devices, additional sub-systems, additional elements, additional structures, or additional components. Appearances of the phrase “in an embodiment,” “in another embodiment” and similar language throughout this specification may, but do not necessarily, all refer to the same embodiment.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Embodiments of the present disclosure will be described below in detail with reference to the accompanying figures.

Disclosed is a method for one or more of charging and reconditioning an electrochemical cell for inhibiting growth of dendrites, wherein the method comprises, applying one of a current and a voltage for achieving a galvanic phase and an electrolytic phase in alternating periods.

Some embodiments use an AC battery charging method that may reduce dendrite growth in metal electrode cells. With the appropriate charging waveform, embodiments may slow dendrite growth. In some embodiments, the method may remove existing dendrites. The AC input primarily includes a time-varying charging current and voltage, but in certain embodiments may include other time-varying or steady-state conditions at the battery anode, including temperature, strain state, strain direction, and pressure.

Some embodiments use a bipolar charge process. By adding a periodic reverse bias shorter than the diffusional timescale of the electrolyte, material may be preferentially removed from the tips of dendrites by operating briefly in an electromigration, rather than a diffusion limited regime. With the appropriate bipolar pulse frequency, as well as a reverse bias pulse that is larger in magnitude (though shorter in duration) than the forward bias pulse, embodiments may be used to recharge a battery in a way that removes dendrites.

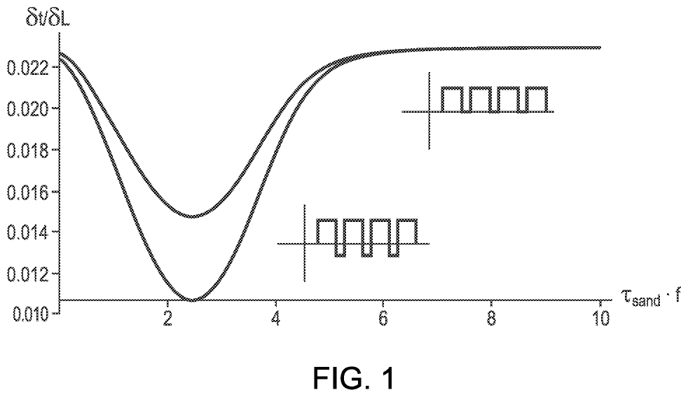

FIG. 1 is a graph illustrating a model of growth on a single thin dendrite in a periodic array. Particularly, FIG. 1 depicts graphs of results of a 1-dimensional model of plating uniformity vs frequency for both unipolar square pulse and bipolar square pulse waveforms. As shown, the plating uniformity is captured by the parameter δt/δL, the incremental change in deposit thickness versus distance along the dendrite. The frequency is nondimensionalized to the diffusional timescale of the electrolyte τ_{sand}≈πD(C₀F/2i₀) for bulk concentration C₀, diffusivity D, and applied current i₀. In this simulation, the duty cycle for both waveforms is 0.8. Average currents are identical, and the reverse current is 50% of the forward value for the bipolar case. The Wagner number Wα=κ(dη/di)/L, widely taken to represent the uniformity of current in a recess region of depth L, solution conductivity K, and polarization slope dη/di, is 1.0 for this simulation, with all currents in a diffusion limitation regime.

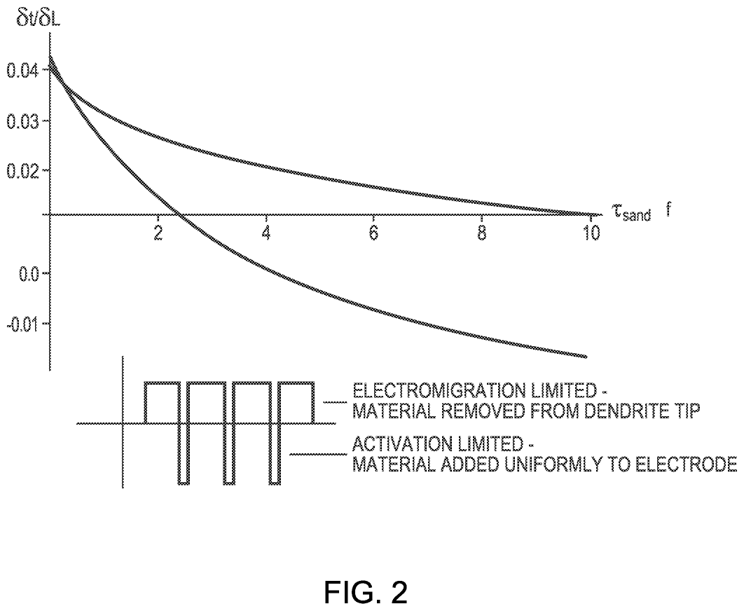

FIG. 2 is graph illustrating effect of electrochemical fire polishing in shrinking a dendrite. Referring to FIG. 2, by operating a reverse-bias pulse in an electromigration (non-diffusive electrolyte conduction) limited regime and a longer forward-bias pulse in an activation limited regime, embodiments may recharge a solid-electrode battery in a way that removes dendrites. This figure was generated by choice of the current duty cycle and magnitude in the same model used to generate FIG. 1, with all currents below the diffusion limitation regime.

Some embodiments may use time-varying discharging methods for electrochemical cells. Some embodiments may use voltage excursions to periodically remove adventitious contaminant layers that have formed during DC battery or electrolyzer operation. Some embodiments may use AC electrocatalysis—a voltage waveform applied to an electrode driving a multi-step reaction, with the exact waveform calibrated to better stabilize different transition states along the reaction path. High frequency portions may be sourced electromagnetically, rather than shifting the bulk electrode potential. Some embodiments may use periodic voltage excursions into gas-generating regimes (H₂, Cl₂ evolution in particular) to sterilize incipient biofilm layers. Some embodiments may use integration of microelectronic buck converters into A, AA, and AAA form factor batteries so that higher voltage, higher energy density chemistries can be used in those battery form factors.

In some embodiments, the time-varying charging waveform is applied to an electrode-electrolyte system under an applied strain that is orthogonal to the electrode-electrolyte interface. This strain may be achieved by applying compressive forces to a single cell, or a multi-cell arrangement. In the case of jelly-roll cell construction, the strain could be achieved by applying compression to a ring of material around the jelly-roll assembly. In another embodiment, the strain state is introduced periodically in phase with the charging waveform, for example by applying a compressive strain to the electrode during the charging pulse and removing the strain during the stripping or relaxed phase. The time-dependent strain could be introduced by mounting the electrode onto a piezoelectric substrate, or by clamping the entire cell assembly in a mechanical actuator as shown in FIG. 3.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A method for one or more of charging and reconditioning an electrochemical cell, the method comprising: applying one of a current and a voltage for achieving a galvanic phase and an electrolytic phase in alternating periods.

2. The method of claim 1, wherein a magnitude of the current applied for achieving the galvanic phase is less than a magnitude of the current applied for achieving in the electrolytic phase.

3. The method of claim 1, wherein a magnitude of a maximum value of the current applied for achieving the galvanic phase is greater than a magnitude of a maximum value of the current applied for achieving the electrolytic phase.

4. The method of claim 1, wherein the electrolytic phase and the galvanic phase switch with a frequency between 0.5 and 4 times of Sand's time for a negative electrode.

5. The method of claim 1, wherein a magnitude and a duration of the applied current for achieving the electrolytic phase is characterized to limit a reaction rate at the negative electrode by electrolyte conduction, and a magnitude and a duration of the applied current for achieving the galvanic phase is characterized to limit a reaction rate at the negative electrode by reaction activation energy.

6. The method of claim 1, further comprising applying time-varying or steady-state conditions at the negative electrode, wherein the conditions comprise one more parameters including temperature, strain state, strain direction, and pressure.

7. The method of claim 1, further comprising periodic voltage excursions for removing adventitious contaminant layers formed during an operation of the electrochemical cell.

8. The method of claim 1, comprising applying a voltage waveform to the electrochemical cell driving a multi-step reaction, wherein the voltage waveform is calibrated to stabilize different transition states along a reaction path.

9. The method of claim 1, comprising using periodic voltage excursions into gas-generating regimes for sterilizing incipient biofilm layers of the metal electrode cells.

10. The method of claim 9, wherein the gas-generating regimes comprise hydrogen and chlorine evolution regimes.

11. The method of claim 1, comprising integrating microelectronic buck converters into the electrochemical cell, wherein the electrochemical cell is a battery with one form factor out of A, AA, and AAA form factors.

12. The method of claim 1, comprising applying a time-varying charging waveform to an electrode-electrolyte interface of the electrochemical cell under an applied mechanical stress, wherein the applied stress is orthogonal to the electrode-electrolyte interface.

13. The method of claim 12, wherein the applied stress is achieved by applying compressive forces to the metal electrode cells.

14. The method of claim 12, wherein the stress is applied periodically by applying a compressive stress to the negative electrode during a charging pulse and removing the compressive stress during a stripping or relaxed phase.

15. The method of claim 12, wherein the stress is applied by mounting the negative electrode onto a piezoelectric substrate.

16. The method of claim 12, wherein the stress is applied by clamping the metal electrode cells in a mechanical actuator.

17. The method of claim 1, wherein the electrochemical cell comprises one or more electrodes made of zinc, lithium, and iron.

18. A device for charging and reconditioning an electrochemical cell, the device comprising:
a circuit for measuring a current-voltage relationship of the electrochemical cell at one or more frequencies to generate impedance spectra;
a circuit for computing an optimal duty cycle and a bipolar magnitude for a charging waveform using the impedance spectra; and
a circuit for applying one of a current and a voltage for achieving a galvanic phase and an electrolytic phase in alternating periods using the charging waveform.

19. The device of claim 18, wherein the impedance spectra is generated periodically throughout the charging process and the charging waveform is changed during the charging process based on the periodic generation of the impedance spectra.

20. The device of claim 18, wherein the device further comprises a circuit for converting a DC galvanic charging current into an alternating electrolytic and galvanic charging current that is partially or wholly contained within a housing of the electrochemical cell.

21. The device of claim 18, wherein the circuit for applying one of a current and a voltage for achieving a galvanic phase and an electrolytic phase in alternating periods is partially or wholly contained within the housing of the electrochemical cell.
